(19) United States
(12) Patent Application Publication
(10) Pub. No.: US 2015/0292475 A1
(43) Pub. Date: Oct. 15, 2015

(54) METHOD FOR PRODUCING A ROTOR BLADE

(71) Applicant: Wooben Properties GmbH, Aurich (DE)

(72) Inventor: Johannes Kannenberg, Aurich (DE)

(73) Assignee: Wobben Properties GmbH, Aurich (DE)

(21) Appl. No.: 14/443,350

(22) PCT Filed: Nov. 15, 2013
(86) PCT No.: PCT/EP2013/073993

§ 371 Date: May 15, 2015

(30) Foreign Application Priority Data
Nov. 15, 2012 (DE) 10 2012 220 937.9

(51) Int. Cl. F03D 1/00; E04H 5/02; F03D 1/06; B23P 15/04

(52) U.S. Cl. CPC F03D 1/001; B23P 15/04; E04H 5/02; F03D 1/06

(57) ABSTRACT

The invention relates to a method for producing a rotor blade of a wind turbine in a two-story producing building with a ground floor level for the production of a first part of a rotor blade, and an upper floor level, which is disposed above the ground floor level, for the production of a second part, for example semifinished products for the rotor blade.

### BACKGROUND

1. Technical Field

This invention relates to a method for producing a rotor blade of a wind power installation, as well as to a production facility for producing a rotor blade of a wind power installation.

2. Description of the Related Art

It is known that rotor blades of a wind power installation comprise various elements, or, respectively, semifinished products. These elements may comprise struts or bridges, for example. These are inserted into the rotor blades at various times during the producing process. In addition, a process for producing a rotor blade of a wind power installation comprises various work steps such as filling the rotor blade mold, infusion with resins, tempering, equipping with bridges and the bonding together of two half shells. The surface of the rotor blade is subsequently treated. This treatment comprises deburring of the outside of the rotor blade, or, respectively, the semifinished products, chamfering of the rotor blade finally coating with a coat of paint.

### BRIEF SUMMARY

One or more embodiments of the invention improves rotor blade production as a whole, to reduce the costs of such production, to facilitate speedier and safer blade production, thereby enabling a faster overall rotor blade production and at the same time, also improving the safety of blade production.

In the priority application for the present application, the German Patent and Trademark Office researched the following prior art: DE 42 26 397 A1, DE 102 08 850 A1, DE 10 2007 033 414 A1, EP 2 226 186 A1, Journal: Windblatt 03/12 of ENERCON, pages 1-20, Prospectus: MDS Raumsysteme 06/2012, pg. 1-28.

According to the method according to one embodiment of the invention, the semifinished product is produced in parallel to the rotor blade and indeed, is produced in the same building, however on levels of that building, so that, for example, the rotor blades are produced on the ground floor, while the semifinished product is produced on the top floor, and the semifinished product on the top floor can be lowered to the ground floor through an opening between the upper floor and the ground floor.

The advantage to this method is that the production can be set up in a very compact manner, and thus the production building can have a much smaller footprint than has previously been the case.

The parts that are produced on the on the upper floor level are preferably transported from the upper floor level to the ground floor level by means of a crane or a cable winch, etc., and thus, can be consolidated with the parts produced on the ground floor level. Thus a load lifting device such as a crane, cable hoist, cable winches in general, a chain hoist, a lifting frame and/or lifting portal is disposed on the two-story production building.

In a preferred embodiment, a first crane, for example a gantry crane is formed on the first upper floor level, for lifting and/or transporting the parts produced there, and in that a second crane, for example a gantry crane, is formed on the ground floor level, for lifting and/or transporting the parts of the rotor blade produced there. In so doing, the load capacity of the first crane (cable) is less than the load capacity of the second crane. The first crane or, respectively the first cable, thus the crane on the upper floor level, has a lower bearing load, since the parts, which are produced on the upper floor level weigh less than the rotor blade itself. In the case of one or more embodiments of the present invention, a semifinished product is understood to be a subcomponent which can be installed in the rotor blade, or in other words, laminated therein. This may be the strut or bridge of the rotor blade, for example. The first or second crane may be a gantry crane, for example. Said crane spans the work area like a portal and can thereby lift or transport very high loads.

In a particularly preferred embodiment, the maximum crane load or, respectively, bearing load of the crane on the ground floor level falls in the range of 30 metric tons (t) to 40 t, while the maximum crane load of the crane on the upper floor level falls in a range between 1 t and 10 t, preferably 5 t. As a result, the half shells of the rotor blade can be transported on the ground floor level, either without, or with the semifinished products already laminated therein. In so doing, the crane load corresponds to the load, which the crane is able to bear or, respectively, transport, thus the bearing load of the crane.

In a further embodiment, an opening is provided between the upper floor level and the ground floor level, in the floor of the upper floor or, respectively, in the ceiling of the ground floor, through which opening the parts, which are produced on the upper floor level, can be lowered to the ground floor level. In so doing, this opening can be closed, for example by means of a plate, which is embedded in the floor of the upper floor level and/or in the ceiling of the ground floor level, which plate can be moved by a motor. In this way, semifinished products, which are produced on the upper floor level can be transported to the ground floor level in an easy and, in particular, direct manner. In so doing, in the case of a corresponding arrangement of the opening, the semifinished product, which is provided for a specific rotor blade, can be lowered directly to the rotor blade at the correct location. In this way, it is possible to avoid long and time consuming transport routes within the production building.

### BRIEF DESCRIPTION OF THE SEVERAL VIEWS OF THE DRAWINGS

Further details and advantages of the invention are disclosed in the

exemplary embodiments according to the drawings.

Shown are:

FIG. 1: a process sequence for producing a rotor blade of a wind power installation,

FIG. 2: producing according to one embodiment of the invention,

FIG. 3: the production flow with half shells,

FIG. 4: a side view of a production facility,

FIG. 5: a mobile carriage,

FIG. 6: two grid binders.

### DETAILED DESCRIPTION

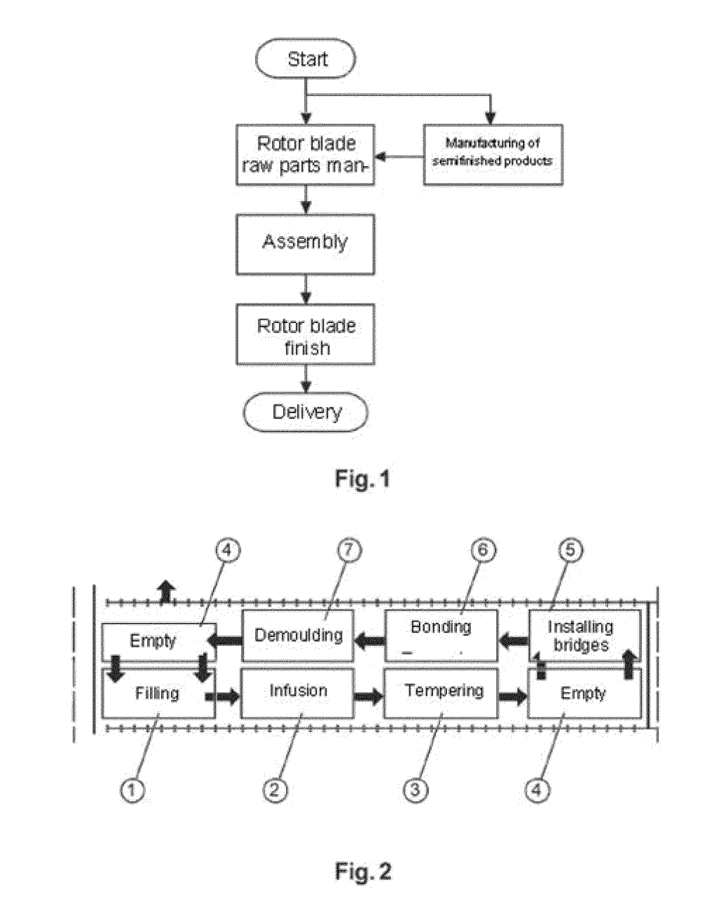

FIG. 1 depicts the general sequence of rotor blade production. In the first step, the half shell, in which the halves of the rotor blade are produced, are filled with fiberglass mats. In so doing, the semifinished product is already inserted into the glass fiber mats. After both half shells have been filled and cured with resins, said shells are bonded so that they form a rotor blade.

After the rotor blades have been formed, they are assembled. Subsumed under this term, for example, is the machining of the flange, testing the lightning protection, etc. In the finishing area, the rotor blade is painted and all of the necessary preparatory steps therefor are carried out.

Once the rotor blade has been painted and all of the necessary preparatory steps have been carried out, the rotor blade is fastened, for example onto a truck, for delivery directly in the production building. In this way, the entire production of the rotor blade all the way to preparation for delivery takes place within the production building.

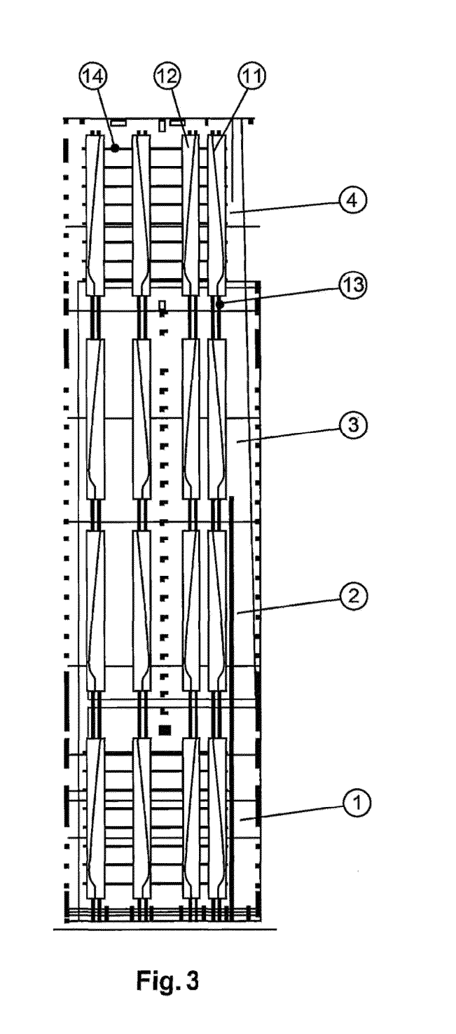

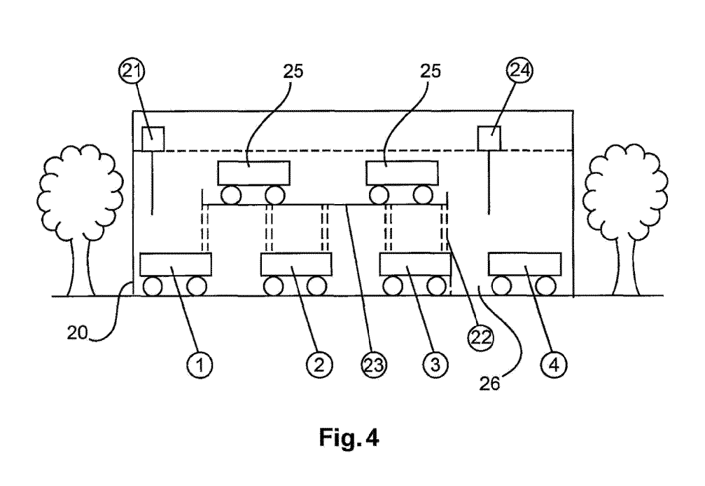

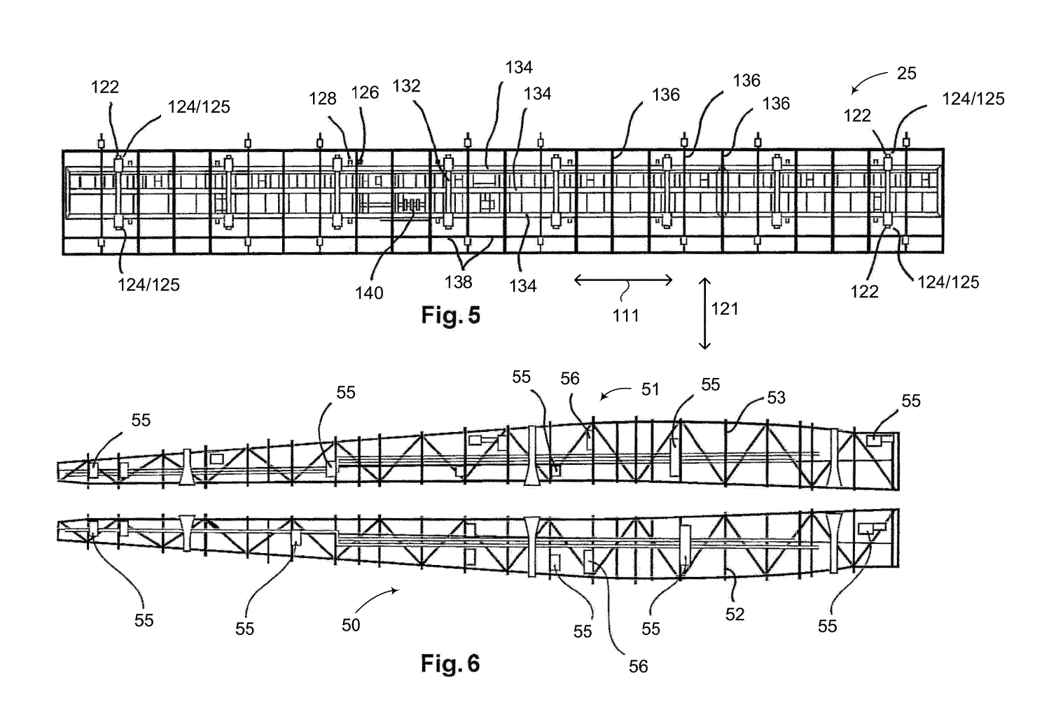

FIG. 2 and FIG. 3 depict the production process for the raw parts for producing a rotor blade of a wind power installation. In so doing, the individual production processes are arranged one after the other. The half shells 11 and 12, which are consolidated after the bonding process, are produced in each production process. In the first step, process step 1, the rotor blade mold is filled. In this step, the belt is inserted into the half shells with the aid of the gantry crane 21 (FIG. 4). After the rotor blade mold has been filled with the, as yet, dry glass fiber mats in a predetermined arrangement of layers, the half shells are transported to the next station, process step 2. Since the space at station 1 is now free, the mold is removed from the empty space 4 at station 1 and thus can be refilled. In order that the molds can move from one station to the next station, said molds are mounted on a mobile carriage. The mobile carriage is depicted in FIG. 5. Only the base frame of the mobile carriage is depicted in this FIG.. The mobile is moved on rails 13.

After the half shells have been filled, the multi-ply weave is impregnated with resins. This is process step 2 of the infusion. A vacuum infusion process is used for this impregnation. As soon as the fiber reinforced material has been impregnated with resins, said material must be heat treated so that the resins react. This process is referred to as tempering. Tempering 3 is performed at a separate station. When changing stations from station 2 to station 3, the mold must be kept in a vacuum. To this end, each rotor blade mold has an energy unit and a vacuum unit, which maintain a vacuum on the mold while moving.

After tempering 3, the mobile carriage is moved to an empty space 4. The carriage is moved transversely from the empty space to the next station. To this end, the rails 14 are mounted transversely to the direction of producing at a 90° angle. In order that the mobile carriage can move transversely, the drive units are rotated 90°.

The bridges are mounted on the half shells and bonded at the station 5. The two half shells are subsequently brought together and bonded in process step 6. This is done with the aid of a bonding portal. After bonding, the half shells, which have been laid one on the other, are again tempered. Upon the completion of the tempering, the rotor blade can be removed from the shell in process step 7. To this end, the upper shell is removed from the lower shell by means of a lever device. The rotor blade is then moved to the empty space 4, from which space it is then brought into the assembly. Upon doing so, the empty mold is again available for the next rotor blade.

FIG. 4 shows a cross-sectional view of the production facility 20. The production facility is divided into two levels (stories), specifically the ground floor level 26 and the upper floor level 23. The rotor blades or, respectively, substantial parts thereof are produced and also assembled on the lower level (ground floor) 26. Semifinished product for the rotor blades are produced on the upper level (upper floor) 23. All of the necessary production facilities, for example such as trimming equipment, molds, etc., for the semifinished products, including a crane there (gantry crane), are located on the upper floor, thus on the upper level. Likewise, the blank for the glass fiber mats for the semifinished products is located on this second, thus upper level (upper floor). Semifinished products of a rotor blade are the belt or the bridges and additional parts, which are installed in the rotor blade, for example. For example, the belt is produced in a first producing process, and the bridges are produced in an additional producing process on the upper floor.

When the molds are filled, the belt is placed on the mold of station 1 by means of the gantry crane of station 23. This is done by lowering the corresponding semifinished product, thus the belt, through an opening between the upper floor 23 and the ground floor 26. This opening is depicted in FIG. 4 between the outer wall of the production facility 20 and the upper floor level. Additional openings for lowering parts from the upper floor to the ground floor are likewise provided (in FIG. 4, on the right). It can also be seen in FIG. 4 that the bridges, for example, can be placed on the mold of station 5 on the ground floor by means of a gantry crane 24.

There are wheels or rollers on the underside of the mobile carriage 25, and some of the rollers or wheels have drives, so that the mobile carriage 25 can also be moved using an active drive, e.g., on the ground floor level or, in the event that the mobile carriage is located on the upper floor level, on that upper floor.

Through at least one embodiment of the invention, it is not only possible to reduce the property area of the production facility by a substantial degree (up to 20% or more), so that overall, a smaller footprint need also be sealed, but it is also possible to significantly increase the length of the production cycle, for example by more than 30%, and at the same time, the entire production sequence is made safer and the production quality is significantly improved because large and heavy parts no longer need to be constantly transported during ongoing operations by means of a gantry crane over people's heads, so that, so that workplace safety is also significantly increased. At the same time, the entire production sequence can be made substantially more fluid by adapting the production steps between the ground floor level and the upper floor level, thus by means of a corresponding production timing.

In the case of the production facility depicted in FIG. 4, it is also possible for the gantry cranes 21 and 24 to transport both parts on the upper floor level and parts on the ground floor level, at any rate, in the region in which there is an opening between the upper floor level and the ground floor level.

At the same time, it is also possible for a separate gantry crane to be provided on the upper floor, which has a lower maximum bearing load, for example up to approximately 5 t, than a gantry crane on the ground floor level. As a result, the overall energy requirement for the entire production is again reduced, and the flexibility in the production and the adaption of the individual production steps to one another are increased.

By separating the production steps and production parts onto at least two levels, specifically the ground floor level and the upper floor level (additional upper floor levels would likewise be possible), the production period is substantially shortened, for example by more than 30% as compared to standard production, in which all of the essential production steps take place on one level, thus in a single, large hall.

FIG. 5 shows a schematic top view of the mobile carriage 25. For illustrative purposes, the longitudinal direction 111 is depicted by a double arrow, and a transverse direction 121 is shown by a double arrow as well. The longitudinal direction 111 and the transverse direction 121 are disposed such that they are essentially perpendicular to one another. In so doing, an angle of precisely 90 degrees is not created between these two directions 111 and 121, however they should not extend parallel to one another.

In FIG. 5, it can be seen that 16 part-changing devices are provided, which together form the changing device 124. A pair of wheels 122 is allocated to each part-changing device 125. In each case, two part-changing devices 125 are attached to longitudinal supports 134 by means of a connection support 132. Jointly lowering the pair of wheels 122 by means of the part-changing device 125 and therefore by means of the changing device 124 results in the lifting of the mobile carriage 25, in particular via these longitudinal supports 134. In so doing, a plurality of transverse supports 136 are disposed on the longitudinal supports 134 or, respectively, the longitudinal supports 134 and the transverse supports 136 are connected to one another in a stable structure of the mobile carriage 25. In addition, various carrier supports 138 are disposed in a longitudinal direction. The longitudinal supports 134, transverse supports 136 and carrier supports 138, which need not be identical, although in this case only one reference sign is used, essentially form the mobile carriage 25 or at least the stable support structure thereof.

Several transverse drives 126 are provided in order to drive the pair of wheels 122, said drives having available a transmission 128. The coupling to the respective pair of wheels 122 is not shown in the overview depiction in FIG. 5. The transverse drives 126 are thereby each mechanically independent transmissions, which are coupled electrically or, respectively synchronized, in order that, in the case of a movement in the transverse direction 121, the movement of the mobile carriage 25 is as uniform and equal as possible. In so doing, not all pairs of wheels 122 of the second set of wheels 120 are driven. In addition, a hydraulic unit 140 is provided, which is provided in order to actuate the changing device 124, and thus the individual parts-changing device 125.

FIG. 6 shows two grid binders 50, 51 of two rotor blade molds, each of which produces the half shell of a rotor blade. The grid binders 50, 51, each have essentially one grid structure 52, 53, in order to carry shaping layer, and in which, heating elements are embedded. This shaping layer may be connected to additional layers in a sandwich structure. In the interest of clarity, this shaping layer is not depicted in FIG. 6, so that it will be easier to see the design of the grid binder 50, 51 and thus of the grid structures 52, 53. A plurality of power supply units 55 is provided for each rotor blade mold, in order to supply the heating elements with electric current. The power supply units may differ from one another in specific details. In order to improve the clarity, however, the same reference sign has been used for each power supply unit. Each power supply unit 55 provides a heating region with electric current, and in so doing, controls the current that is to be supplied in each case. In addition, a central control unit 56 is provided in each case, in order to supply the power supply units 55 with switch commands. The entire control of the respective rotor blade mold is coordinated, and processes and states, in particular temperatures, can be displayed on the central control unit 56. Manual intervention can also be performed via the central control unit 56.

The power supply units 55 are supplied with electric power via the power bus-bars. In addition, the power bus-bars are used to transfer data between the power supply unit 55 and the central control unit 56. A separate power bus-bar and a separate data bus-bar may also be provided. The power supply unit 55 and the central control unit 56 are disposed within the grid structures 52, 53.

### KEY

1. Process step: filling
2. Process step: infusion
3. Process step: tempering
4. Empty space
5. Process step: placing bridges
6. Process step: bonding the half shells and tempering
7. Process step: Demolding the rotor blade
11. Half shell suction side
12. Half shell pressure side
13. Rails for longitudinal movement of the mobile carriage
14. Rails for transverse movement
20. Producing building
21. Gantry crane 1
22. Buttress for supporting the second producing level
23. Second production level (upper floor)
24. Gantry crane 2
25. Mobile carriage
26. First production level (ground floor)
50./51. Grid binder
52./53. Grid structure
55. Power supply unit
56. Central control unit
111. Longitudinal direction
121. Transverse direction
122. Pair of wheels
124. Changing device
125. Part-changing device
126. Transverse drive
128. Transmission
132. Connection support
134. Longitudinal support
136. Transverse support
138. Carrier support
140. Hydraulic power unit

1. A method for producing a rotor blade of a wind turbine:
forming a first part of the rotor blade on a ground floor level of a two-story building:
forming a second part of the rotor blade on an upper floor level of the two-story building, the upper floor level being located disposed above the ground floor level; and
coupling the first part and the second part together to form the rotor blade.

2. The method according to claim 1, wherein on the ground floor level and on the upper floor level, forming the first and second parts is done simultaneously, and further comprising transporting the second part from the upper floor level to the ground floor level using a crane or a cable winch prior to coupling the first and second parts together.

3. The method according to claim 1, further comprising:
using a first crane on the upper floor level for lifting and transporting the second parts, and
using a second crane on the ground floor level for lifting and transporting the first parts, wherein the load capacity of the first crane is less than the load capacity of the second crane.

4. The method according to claim 3, wherein the maximum crane load of the second crane on the ground floor level falls in a range of 30 t to 40 t, and the maximum crane load of the first crane on the upper floor level falls in a range between 1 t and 10 t.

5. The method according to claim 1, wherein an opening is provided in the upper floor level that places the upper floor level in open communication with the ground floor level, the method further comprising:
moving parts through the opening to travel between the upper floor level and the ground floor level, and
selectively closing the opening by moving a plate over the opening, wherein the plate is embedded in at least one of the upper floor level and a ceiling of the ground floor level.

6. A production facility for producing a rotor blade of a wind power installation, the production facility comprising:
a ground floor level for the production of a first part of the rotor blade,
an upper floor level for the production of a second part of the rotor blade, wherein
a first crane disposed on the upper floor level and configured to lift and transports the first part of the rotor blade produced there, and
a second crane disposed on the ground floor level and configured to lift and transport the second part of the rotor blade produced there.

7. The production facility according to claim 6, further comprising an opening in the upper floor level that places the upper floor level in open communication with the ground floor level such that parts can be provided through the opening to travel between upper floor level and the ground floor level.

8. (canceled)

9. The method according to claim 1, wherein on the first and second parts is formed in parallel.

10. The method according to claim 4, wherein the maximum crane load of the first crane is 5 t.

11. The method according to claim 6, wherein the first and second cranes are gantry cranes.
